(19) United States
(12) Patent Application Publication
(10) Pub. No.: US 2025/0284002 A1
(43) Pub. Date: Sep. 11, 2025

(54) ABNORMALITY DETERMINATION APPARATUS, ABNORMALITY DETERMINATION METHOD, ABNORMALITY DETERMINATION PROGRAM, AND VEHICLE

(71) Applicant: Panasonic Automotive Systems Co., Ltd., Kanagawa (JP)

(72) Inventor: Takeshi SUZUKI, Kanagawa (JP)

(21) Appl. No.: 19/068,777

(22) Filed: Mar. 3, 2025

(30) Foreign Application Priority Data
Mar. 7, 2024 (JP) 2024-035129

(51) Int. Cl. G01S 15/931; G01S 7/52; G01S 7/539

(52) U.S. Cl. CPC G01S 15/931; G01S 7/52006; G01S 7/539

(57) ABSTRACT

An abnormality determination apparatus includes: a reception circuitry which, in operation, receives a feature of a reflection wave corresponding to an ultrasonic signal transmitted by each sonar apparatus; and an abnormality determination circuitry which, in operation, determines an abnormality of each sonar apparatus based on a difference in the feature.

### TECHNICAL FIELD

The present disclosure relates to an abnormality determination apparatus, an abnormality determination method, an abnormality determination program, and a vehicle.

### BACKGROUND ART

In recent years, various sensors such as sonar apparatuses have been configured to be mounted on vehicles. A sonar apparatus can detect the presence of a target object by transmitting ultrasonic waves and receiving the ultrasonic waves reflected by the target object. Additionally, the sonar apparatus can measure the distance to the target object by calculating the time difference between the transmission and reception of the ultrasonic waves. The vehicle prevents a collision with the target object by operating the emergency brake or the steering wheel based on the detected target object.

For example, PTL 1 discloses the temperature feature of a sonar sensor as one of the factors of the reduction in the detection accuracy of the sonar sensor (sonar apparatus). PTL 1 discloses that the reception sensitivity of the transmission wave or the transmission intensity of the transmission wave is corrected according to the temperature measured by the temperature sensor in order to reduce the influence of the temperature feature of the sonar sensor and improve the detection accuracy.

### CITATION LIST

### Patent Literature

### PTL 1

Japanese Patent Application Laid-Open No. 2017-096771.

### SUMMARY OF INVENTION

An object of an embodiment of the present disclosure is to provide an abnormality determination apparatus, a method, a program, and a vehicle including the abnormality determination apparatus that can detect a sonar apparatus with decreased detection accuracy.

### Solution to Problem

An abnormality determination apparatus of an embodiment of the present disclosure includes: a reception circuitry which, in operation, receives a feature of a reflection wave corresponding to an ultrasonic signal transmitted by each sonar apparatus; and an abnormality determination circuitry which, in operation, determines an abnormality of each sonar apparatus based on a difference in the feature.

A vehicle of an embodiment of the present disclosure includes an abnormality determination apparatus including: a reception circuitry which, in operation, receives a feature of a reflection wave corresponding to an ultrasonic signal transmitted by each sonar apparatus; and an abnormality determination circuitry which, in operation, determines an abnormality of each sonar apparatus based on a difference in the feature.

An abnormality determination method of an embodiment of the present disclosure includes: receiving a feature of a reflection wave corresponding to an ultrasonic signal transmitted by each sonar apparatus, and determining an abnormality of each sonar apparatus based on a difference in the feature.

A computer-readable storage medium of an embodiment of the present disclosure stores an abnormality determination program that causes a computer to execute: a reception step of receiving a feature of a reflection wave corresponding to an ultrasonic signal transmitted by each sonar apparatus; and an abnormality determination step of determining an abnormality of each sonar apparatus based on a difference in the feature.

### Advantageous Effects of Invention

According to the present disclosure, it is possible to provide an abnormality determination apparatus, a method, a program, and a vehicle including the abnormality determination apparatus that can detect a sonar apparatus with decreased detection accuracy.

### BRIEF DESCRIPTION OF DRAWINGS

FIG. 1 is a block diagram of a sonar apparatus;

FIG. 2 is a top view of a vehicle;

FIG. 3 is a diagram illustrating an ECU;

FIG. 4 is a diagram illustrating an example of an operation order of the sonar apparatus;

FIG. 5 is a diagram illustrating another example of an operation order of the sonar apparatus; and

FIG. 6 is a flowchart describing processing of the ECU.

### DESCRIPTION OF EMBODIMENTS

Embodiments of the present disclosure will be described in detail below with reference to the drawings. The embodiments described below are examples, and the disclosure is not limited to the following embodiments.

However, more detailed explanations than necessary may be omitted. For example, detailed explanations of matters already well known or duplicate explanations for substantially identical configurations may be omitted. This is to avoid unnecessary redundancy in the following explanations and to facilitate the understanding of those skilled in the art.

In the embodiment of the present disclosure, the temperature of exhaust gas around the sonar apparatus and adherents on the sonar apparatus are described as factors that reduce the detection accuracy of the sonar apparatus, but the present disclosure is not limited thereto.

Hereinafter, an embodiment of the present disclosure will be described with reference to the drawings.

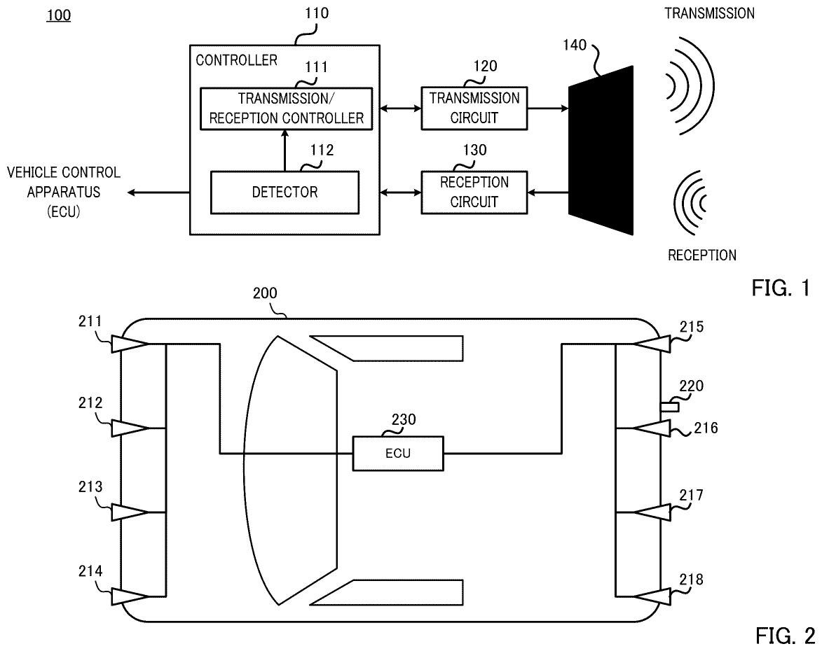

FIG. 1 is an exemplary block diagram of sonar apparatus 100. Sonar apparatus 100 is an apparatus that performs detection of the target object and the like by transmitting an ultrasonic signal and receiving an ultrasonic signal reflected by a target object (object). Sonar apparatus 100 is configured to be mounted on, for example, a vehicle.

Sonar apparatus 100 includes controller 110, transmission circuit 120, reception circuit 130, and microphone 140. Each sonar apparatus 100 includes microphone 140. A plurality of sonar apparatuses 100 is configured to be mounted on the vehicle. Note that, FIG. 1 illustrates a configuration in which microphone 140 is composed of a single microphone, but microphone 140 may be composed of a plurality of microphones.

Controller 110 includes transmission/reception controller 111 and detector 112. Controller 110 outputs detection results of the target object to a vehicle control apparatus (Electronic Control Unit: ECU). The ECU can perform vehicle control, such as activation of the emergency brake or control of the vehicle traveling direction, based on the detection results from sonar apparatus 100.

Transmission/reception controller 111 controls transmission circuit 120 and reception circuit 130. Transmission/reception controller 111 controls the timing of transmission of the ultrasonic signal by transmission circuit 120, the frequency of the ultrasonic signal, and the transmission time of the ultrasonic signal.

Transmission/reception controller 111 causes transmission circuit 120 to transmit the ultrasonic signal multiple times in each period. The frequency of each ultrasonic signal to be transmitted is different for each sonar apparatus 100, and is, for example, 60 kHz, 70 kHz, 80 kHz, and the like. Transmission/reception controller 111 may change the frequency of the ultrasonic signal to be transmitted for each period based on the chirp signal. Detector 112 detects the received ultrasonic signal.

Transmission circuit 120 generates a transmission signal based on the control of transmission/reception controller 111 and outputs the generated transmission signal to microphone 140. Reception circuit 130 outputs the reception signal to detector 112 based on the reception signal received from microphone 140. Reception circuit 130 may include a frequency filter, a Fourier transformer, and the like.

Microphone 140 is an electroacoustic transducer that transmits an ultrasonic signal based on the transmission signal received from transmission circuit 120 and transmits a reception signal to reception circuit 130 based on the received ultrasonic signal.

FIG. 2 is a top view of vehicle 200. Vehicle 200 includes sonar apparatuses 211 to 218, muffler 220, and ECU 230. In the example of FIG. 2, four sonar apparatuses 211 to 214 are configured to be mounted on the front part of the vehicle, and four sonar apparatuses 215 to 218 are configured to be mounted on the rear part of the vehicle.

Sonar apparatus 211 is disposed at the front right (FR). Sonar apparatus 212 is disposed at the front right center (FRC). Sonar apparatus 213 is disposed at the front left center (FLC). Sonar apparatus 214 is disposed on the front left side (FL).

Further, sonar apparatus 215 is disposed at the rear right (RR). Sonar apparatus 216 is disposed at the rear right center (RRC). Sonar apparatus 217 is disposed at the rear left center (RLC). Sonar apparatus 218 is disposed at the rear left side (RL).

As sonar apparatuses 211 to 218, for example, sonar apparatus 100 in FIG. 1 is used. Further, the number and arrangement of the sonar apparatuses are not limited to those illustrated in FIG. 2. The number of sonar apparatuses configured to be mounted on the vehicle may not be eight, the number of sonar apparatuses configured to be mounted on the front and rear may be different, and the sonar apparatus may be provided on the side surface of the vehicle.

Muffler 220 discharges exhaust gas. For example, in FIG. 2, muffler 220 is disposed near sonar apparatus 216. Note that, depending on vehicle 200, the arrangement of muffler 220 differs, and therefore the sonar apparatus disposed nearby may also differ. Further, vehicle 200 may include a plurality of mufflers 220.

ECU 230 is connected to sonar apparatuses 211 to 218 and controls controller 110 of sonar apparatuses 211 to 218.

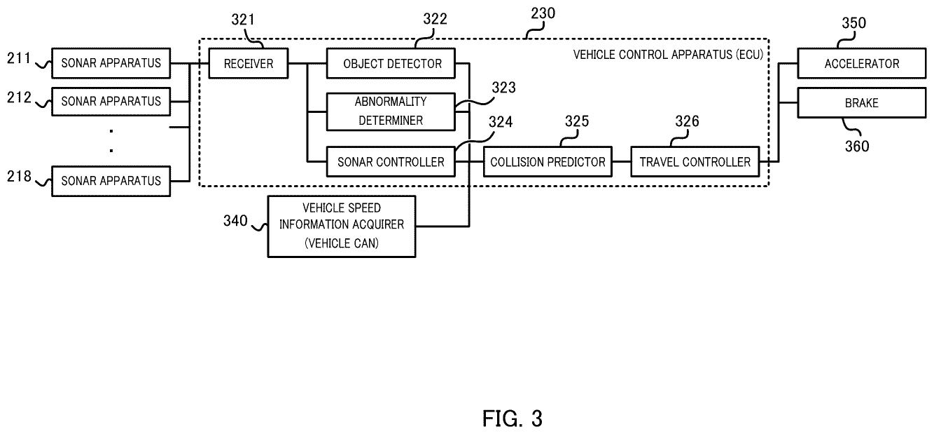

FIG. 3 is a diagram illustrating ECU 230. Sonar apparatuses 211 to 218, vehicle speed information acquirer (vehicle CAN: Controller Area Network) 340, accelerator 350, and brake 360 are connected to ECU 230.

ECU 230 includes receiver 321, object detector 322, abnormality determiner 323, sonar controller 324, collision predictor 325, and travel controller 326.

Receiver 321 is connected to sonar apparatuses 211 to 218 and receives signals indicating the feature of the reflection waves measured by each of sonar apparatuses 211 to 218. The features of the reflection wave are Time of Flight (TOF), TOF variation, wave height, and wave height variation. The received signal is transmitted to object detector 322 and abnormality determiner 323.

Object detector 322 performs at least one of detection of a target object and/or measurement of a distance to the target object (hereinafter, simply referred to as “detection of a target object”) based on a signal indicating a feature of a reflection wave received from a sonar apparatus to be subjected to detection of a target object. The sonar apparatus to be subjected to detection of a target object is notified by sonar controller 324.

Abnormality determiner 323 determines an abnormality in the sonar apparatus based on a difference in signals indicating the feature of the reflection waves received by each sonar apparatus. The feature of the reflection wave is, for example, at least one of TOF, a TOF variation, a wave height, and/or a wave height variation. Abnormality determiner 323 notifies sonar controller 324 of the sonar apparatus determined to be abnormal.

Abnormality determiner 323 determines that sonar apparatus 216 is abnormal when the difference between the TOF received from sonar apparatus 216 and the TOF received from sonar apparatuses 215, 217, and 218 is equal to or greater than a predetermined value in a condition where sonar apparatuses 215, 216, 217, and 218 detect the reflection of ultrasonic waves from the same object such as the ground, for example.

Further, abnormality determiner 323 determines that sonar apparatus 216 is abnormal when the difference between the TOF variation received from sonar apparatus 216 and the TOF variation received from sonar apparatuses 215, 217, and 218 is equal to or greater than a predetermined value in a condition where sonar apparatuses 215, 216, 217, and 218 detect the reflection of ultrasonic waves from the same object such as the ground, for example.

Further, abnormality determiner 323 determines that sonar apparatus 216 is abnormal when the difference between the wave height received from sonar apparatus 216 and the wave heights received from sonar apparatuses 215, 217, and 218 is equal to or greater than a predetermined value in a condition where sonar apparatuses 215, 216, 217, and 218 detect the reflection of ultrasonic waves from the same object such as the ground, for example.

Further, abnormality determiner 323 determines that sonar apparatus 216 is abnormal when the difference between the wave height variation received from sonar apparatus 216 and the wave height variation received from sonar apparatuses 215, 217, and 218 is equal to or greater than a predetermined value in a condition where sonar apparatuses 215, 216, 217, and 218 detect the reflection of ultrasonic waves from the same object such as the ground, for example.

Note that, as will be described later, each sonar apparatus may calculate at least one of the TOF variation and/or the wave height variation and the receiver 321 may receive at least one of the TOF variation and/or the wave height variation. Alternatively, each sonar apparatus may not calculate at least one of the TOF variation and/or the wave height variation, and the receiver 321 may receive at least one of TOF and/or the wave height, and, the abnormality determiner 323 may calculate at least one of the TOF variation and/or the wave height variation.

Further, some sonar apparatus may calculate at least one of the TOF variation and/or the wave height variation, and abnormality determiner 323 may calculate at least one of the TOF variation and/or the wave height variation of the sonar apparatus that has not received at least one of the TOF variation and/or the wave height variation.

For example, sonar apparatus 211 transmits an ultrasonic signal and receives an ultrasonic signal that is reflected by a target object. Sonar apparatus 211 detects time of flight (TOF), which is the time from transmission to reception, and the wave height of the received ultrasonic signal.

Then, sonar apparatus 211 calculates the TOF variation and the wave height variation based on the TOF and the wave height detected multiple times. Sonar apparatus 211 transmits to ECU 230 the detected TOF and wave height, as well as the calculated TOF variation and wave height variation.

Each of sonar apparatuses 211 to 218 has the same configuration, and each of sonar apparatuses 212 to 218 also executes the same processing.

Sonar controller 324 controls sonar apparatuses 211 to 218. Sonar controller 324 determines whether each sonar apparatus is a sonar apparatus to be subjected to detection of a target object (hereinafter, referred to as a “detection sonar apparatus”) or a sonar apparatus to be subjected to abnormality determination (hereinafter, referred to as an “abnormality determination sonar apparatus”) in accordance with the traveling direction of the vehicle.

Then, sonar controller 324 notifies abnormality determiner 323 of which sonar apparatus is the abnormality determination sonar apparatus, and notifies object detector 322 of which sonar apparatus is the detection sonar apparatus.

For example, when the vehicle is moving forward, sonar controller 324 operates front sonar apparatuses 211 to 214 as detection sonar apparatuses to perform detection of a target object in front of the vehicle, and operates rear sonar apparatuses 215 to 218 as abnormality determination sonar apparatuses to perform the abnormality determination process according to the present disclosure. When the vehicle is moving backward, sonar controller 324 operates rear sonar apparatuses 215 to 218 as detection sonar apparatuses to perform detection of a target object in front of the vehicle, and operates front sonar apparatuses 211 to 214 as abnormality determination sonar apparatuses to perform the abnormality determination process according to the present disclosure. Note that, when the vehicle is traveling at a speed equal to or greater than a predetermined speed, when the vehicle is stopped, or both, sonar controller 324 may operate all sonar apparatuses 211 to 218 to perform the abnormality determination process according to the present disclosure as abnormality determination sonar apparatuses.

Sonar controller 324 causes abnormality determination sonar apparatuses 215 to 218 to increase the sound pressure to be transmitted and transmit the ultrasonic signal. Each of abnormality determination sonar apparatuses 215 to 218 can receive an ultrasonic signal reflected on the ground by transmitting an ultrasonic signal with increased sound pressure. Abnormality determination sonar apparatuses 215 to 218 measure the feature of the received ultrasonic signal. The sound pressure transmitted by abnormality determination sonar apparatuses 215 to 218 may be the maximum sound pressure, a predetermined sound pressure, or a sound pressure corresponding to the speed of the vehicle.

The feature to be measured is, for example, TOF and wave height, but may be either TOF or wave height, or may be another feature. Whether the ultrasonic signal is reflected on the ground can be determined by TOF. Further, by measuring the feature of the ultrasonic signal multiple times, it is possible to calculate the variation of the feature of the ultrasonic signal.

For example, in the ultrasonic signal that is affected by the temperature increase due to the exhaust gas from the muffler and is received by the sonar apparatus, the feature changes because the influence of the exhaust gas is not uniform. For example, since at least one of TOF and/or the wave height varies, at least one of the TOF variation and/or the wave height variation increases.

Accordingly, ECU 230 can determine that an abnormality has occurred in one sonar apparatus when at least one of the TOF variation and/or the wave height variation of one sonar apparatus is larger than at least one of the TOF variation and/or the wave height variation of another sonar apparatus by a predetermined value or more.

For example, the feature of the ultrasonic signal received by a sonar apparatus with a microphone affected by adherents is affected by the adherents, and consequently at least one of the TOF and/or the wave height changes as compared to a sonar apparatus with no adherents.

For this reason, ECU 230 can determine that an abnormality has occurred in one sonar apparatus when at least one of the TOF and/or the wave height of one sonar apparatus has a difference of a predetermined value or more from at least one of the TOF and/or the wave height of another sonar apparatus. At least one of the average of TOF and/or the average of the wave height may be used instead of at least one of TOF and/or the wave height.

Since the detection of the feature of the ultrasonic signal by the sonar apparatus is performed based on a plurality of measurements to improve reliability, it is preferable to determine an abnormality based on a value obtained from a plurality of measurements, such as at least one of the variation and/or the average of the feature.

Abnormality determiner 323 may estimate the cause of the abnormality based on a condition where an occurrence of an abnormality is determined such as the feature of the ultrasonic signal, for example. For example, abnormality determiner 323 may estimate that it is influenced by exhaust gas when at least one of the TOF variation and/or the wave height variation of one sonar apparatus is larger than at least one of the TOF variation and/or the wave height variation of another sonar apparatus by a predetermined value or more.

Further, in a case where at least one of the TOF variation and/or the wave height variation of one sonar apparatus is smaller (or is the same as that of another sonar apparatus) but at least one of the TOF and/or the wave height of one sonar apparatus is smaller than at least one of the TOF and/or the wave height of another sonar apparatus by a predetermined value or more, abnormality determiner 323 may estimate that it is influenced by adherents.

Note that, when the vehicle is moving forward, sonar apparatuses 211 to 214 disposed at the front are used as detection sonar apparatuses and sonar apparatuses 215 to 218 disposed at the rear are used as abnormality determination sonar apparatuses, whereas when the vehicle is moving backward, sonar apparatuses 215 to 218 disposed at the rear are used as detection sonar apparatuses and sonar apparatuses 211 to 214 disposed at the front are used as abnormality determination sonar apparatuses.

Further, sonar controller 324 transmits to the detection sonar apparatus a control signal to perform transmission of an ultrasonic signal for detecting a target object, and transmits to the abnormality determination sonar a control signal to perform transmission of an ultrasonic signal for determining an abnormality. Sonar controller 324 may notify object detector 322 of which sonar apparatus is the detection sonar apparatus, and may notify abnormality determiner 323 of whether the sonar apparatus is the abnormality determination sonar apparatus.

For example, sonar controller 324 transmits any control signal to each sonar apparatus in accordance with the detection cycle. Sonar controller 324 does not use a sonar apparatus determined to be abnormal as a detection sonar apparatus until it is determined that the abnormality has been recovered.

In the example of FIG. 2, four sonars are configured to be mounted on the front and rear of the vehicle, respectively, to detect the target object. In order to prevent interference between the sonar apparatuses, sonar controller 324 causes the sonar apparatuses at both ends of the vehicle (sonar apparatuses 211 and 214, 215 and 218) to transmit ultrasonic signals simultaneously, while the sonar apparatuses at the center of the vehicle (sonar apparatuses 212 and 213, 216 and 217) to transmit ultrasonic signals individually.

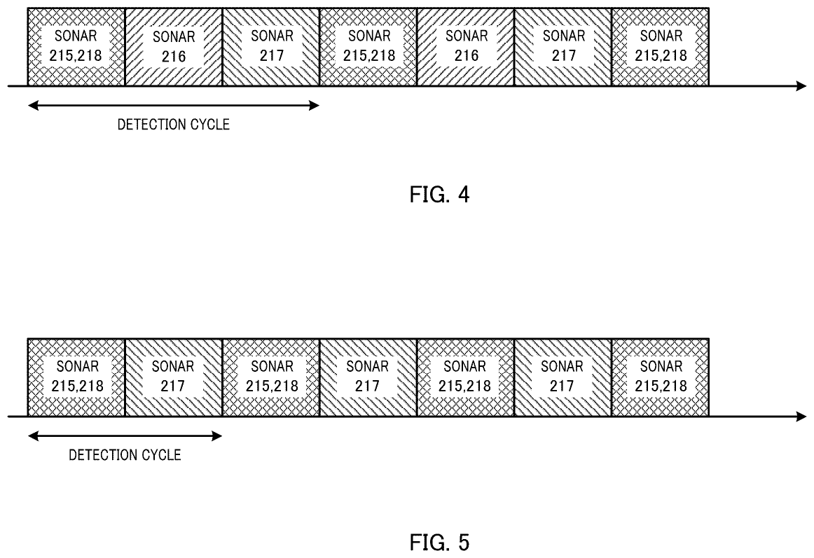

FIG. 4 is a diagram illustrating an example of an operation order of a sonar apparatus in a case where the sonar apparatus determined to be abnormal is not included. FIG. 5 is a diagram illustrating an example of an operation order of a sonar apparatus in a case where the sonar apparatus determined to be abnormal is included. For example, when the vehicle is moving backward, sonar controller 324 causes the sonar apparatus configured to be mounted on the rear part of the vehicle to operate periodically in the order illustrated in FIG. 4. For example, sonar controller 324 periodically operates each sonar apparatus in the following order: (1) sonar apparatuses 215 and 218, (2) sonar apparatus 216, and (3) sonar apparatus 217. In this case, in a case where the operation time of each sonar apparatus is T, the detection cycle is 3T.

Here, for example, in a case where sonar controller 324 determines that sonar apparatus 216 is abnormal among detection sonar apparatuses 215 to 218, sonar controller 324 excludes sonar apparatus 216 from the sonar apparatuses to be operated in the detection cycle, and operates the remaining sonar apparatuses periodically in the order of FIG. 5.

In this case, the detection cycle is 2T, and sonar controller 324 operates each sonar apparatus in the order of (1) sonar apparatuses 215 and 218 and (2) sonar apparatus 217 periodically.

Sonar controller 324 shortens the detection cycle by excluding the sonar apparatus determined to be abnormal from the sonar apparatuses to be operated in the detection cycle. In this case, each sonar apparatus detects the target object with a short detection cycle, thereby preventing a decrease in the detection capability due to a decrease in the number of detection sonar apparatuses.

Alternatively, sonar controller 324 may not change the operation order while excluding the sonar apparatus determined to be abnormal from the operation. For example, in a case where sonar apparatus 216 is determined to be abnormal in FIG. 4, sonar controller 324 may not operate any sonar at the operation timing of sonar apparatus 216 in FIG. 4. At the operation timing of sonar apparatus 216 in FIG. 4, sonar controller 324 may cause sonar apparatus 216 to transmit an ultrasonic signal for determining an abnormality.

In sonar controller 324, abnormality determiner 323 can determine whether the sonar apparatus determined to be abnormal has recovered from the abnormality by continuing to subject that sonar apparatus to the abnormality determination.

Collision predictor 325 predicts whether the vehicle will collide with the target object based on the detection result of the target object by object detector 322, the speed information of the vehicle from vehicle speed information acquirer 340 (hereinafter referred to as “vehicle speed information”), and the like. Travel controller 326 controls acceleration device 440, brake device 450, and the like based on the result of the collision prediction of collision predictor 325.

Vehicle speed information acquirer 340 is a device that acquires vehicle speed information, acceleration device 440 is a device that accelerates the vehicle, and brake device 450 is a device that applies braking to the vehicle.

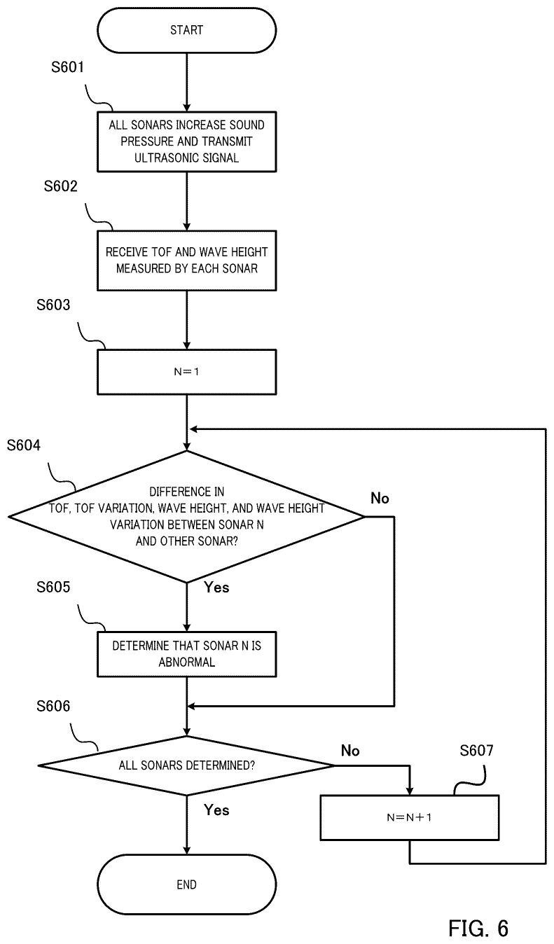

FIG. 6 is a flowchart describing a processing of ECU 230. The following describes a case where an abnormality of each sonar apparatus is determined based on the TOF, the wave height, the TOF variation, and the wave height variation between the sonar apparatuses.

First, ECU 230 causes all sonar apparatuses not performing target object detection to increase the sound pressure and transmit an ultrasonic signal (step S601). The sonar apparatuses not performing target object detection are sonar apparatuses installed at the rear in a case where the vehicle is moving forward, for example.

Next, ECU 230 receives a signal indicating at least one of the TOF and/or the wave height of the received ultrasonic signal measured by each sonar apparatus (step S602). ECU 230 may receive at least one of the TOF variation and/or the wave height variation that are calculated based on at least one of the TOF and/or the wave height measured by each sonar apparatus.

Note that, ECU 230 may calculate at least one of the TOF variation and/or the wave height variation based on a signal indicating at least one of TOF and/or the wave height received from each sonar apparatus without receiving a signal indicating at least one of the TOF variation and/or the wave height variation from each sonar apparatus. ECU 230 may proceed to step S603 after receiving a signal indicating at least one of TOF and/or the wave height measured multiple times to calculate at least one of the TOF variation and/or the wave height variation.

Subsequently, ECU 230 determines the first sonar apparatus to be subjected to the determination of the presence or absence of an abnormality (step S603). Hereinafter, the sonar apparatus to be subjected to the determination of the presence or absence of an abnormality will be referred to as sonar apparatus N (N=1, 2, 3 . . . ).

ECU 230 compares the TOF, wave height, TOF variation and wave height variation received from sonar apparatus N, with the TOF, wave height, TOF variation and wave height variation received from a sonar apparatus other than sonar apparatus N to determine whether there is a difference equal to or greater than a predetermined value (step S604).

When it is determined in step S604 that there is a difference equal to or larger than a predetermined value in any of TOF, the wave height, the TOF variation, and the wave height variation (step S604, Yes), ECU 230 determines that sonar Nis abnormal (step S605).

Note that ECU 230 may further estimate the cause of the abnormality. For example, ECU 230 may estimate that the cause of the abnormality is adherents when there is a difference of a predetermined value or more in at least one of the TOF and/or the wave height, but there is no difference of a predetermined value or more in at least one of the TOF variation and/or the wave height variation, whereas ECU 230 may estimate that the cause of the abnormality is the temperature of the exhaust gas when there is a difference of a predetermined value or more in at least one of the TOF and/or the wave height, and there is a difference of a predetermined value or more in at least one of the TOF variation and/or the wave height variation. If both are applicable, the abnormality may be estimated to be due to both reasons.

When there is no difference equal to or larger than a predetermined value in any of the TOF, the wave height, the TOF variation, and the wave height variation (step S604, No), ECU 230 does not determine that there is an abnormality, and proceeds to step S606.

Then, ECU 230 determines whether the presence or absence of an abnormality has been determined for all sonar apparatuses (step S606).

When ECU 230 has not determined the presence or absence of an abnormality for all sonar apparatuses (step S606, No), ECU 230 selects the next sonar apparatus (step S607) and returns to step S604.

When ECU 230 has determined the presence or absence of an abnormality for all sonar apparatuses (step S606, Yes), the processing ends.

Note that while the processing illustrated in FIG. 6 is executed repeatedly, ECU 230 may exclude the sonar apparatus determined to be abnormal from the sonar apparatuses to be operated in the detection cycle as illustrated FIGS. 4 and 5.

Various embodiments have been described with reference to the drawings hereinabove. For a person skilled in the art, it is clear that various changes and modifications are conceivable within the scope described in the claims. Such variations or modifications are also understood to belong to the technical scope of the present disclosure. Further, in a range that does not depart from the spirit of the present disclosure, each constituent in the embodiment may be combined arbitrarily.

Note that in the present disclosure, the temperature of exhaust gas around the sonar apparatus and adherents on the sonar apparatus are described as factors that reduce the detection accuracy of the sonar apparatus, but other factors, such as a disconnection within the sonar apparatus or a disconnection in the wiring connected to an external apparatus, may also be applied.

In this manner, the sonar apparatus can simplify the structure by eliminating the needs for installation of a temperature sensor with high measurement accuracy, and thus can prevent an increase in manufacturing costs. Further, since the abnormality of the sonar apparatus is determined using the feature of the reflection wave, it is possible to determine the abnormality of the sonar apparatus due to adherents on the sonar apparatus, disconnection of wiring from an external apparatus connected to the sonar apparatus, or a failure of the sonar apparatus itself, as well as due to temperature changes caused by exhaust gas.

In the above description, the notation “ . . . part” used for each component may be replaced by other notation such as “ . . . assembly,” “ . . . circuitry,” “ . . . device,” “ . . . unit,” or “ . . . module. The abnormality determination device may also be configured to be executed by a CPU using a program stored in a memory.

(1) An abnormality determination apparatus of an embodiment of the present disclosure includes: a reception circuitry which, in operation, receives a feature of a reflection wave corresponding to an ultrasonic signal transmitted by each sonar apparatus; and an abnormality determination circuitry which, in operation, determines an abnormality of each sonar apparatus based on a difference in the feature.

(2) In the abnormality determination apparatus according to (1) of an embodiment of the present disclosure, the feature is at least one of a time of flight, a variation in the time of flight, a wave height, and/or a variation in the wave height.

(3) In the abnormality determination apparatus according to (1) of an embodiment of the present disclosure, the abnormality determination circuitry which, in operation, estimates a cause of the abnormality based on the difference in the feature.

(4) The abnormality determination apparatus according to (1) of an embodiment of the present disclosure, further includes: a sonar control circuitry which, in operation, determines whether each sonar apparatus is a sonar apparatus to be subjected to abnormality determination or a sonar apparatus to be subjected to detection of a target object.

(5) In the abnormality determination apparatus according to (4) of an embodiment of the present disclosure, the sonar control circuitry which, in operation, determines whether the sonar apparatus is the sonar apparatus to be subjected to the abnormality determination or the sonar apparatus to be subjected to the detection of the target object in accordance with a traveling direction of the vehicle.

(6) In the abnormality determination apparatus according to (4) of an embodiment of the present disclosure, the sonar control circuitry which, in operation, determines the sonar apparatus to be subjected to the detection of the target object with excluding a sonar apparatus determined to be abnormal by the abnormality determiner excluded.

(7) In the abnormality determination apparatus according to (6) of an embodiment of the present disclosure, the sonar control circuitry which, in operation, operates the sonar apparatus to be subjected to the detection of the target object in an order excluding the sonar apparatus determined to be abnormal from a predetermined order.

(8) In the abnormality determination apparatus according to (4) of an embodiment of the present disclosure, the sonar control circuitry which, in operation, operates the sonar apparatus to be subjected to the detection of the target object in a predetermined order; and the abnormality determination circuitry which, in operation, determines again the abnormality for the sonar apparatus determined to be abnormal at a timing of the sonar apparatus determined to be abnormal within the predetermined order.

(9) A vehicle of an embodiment of the present disclosure includes the abnormality determination apparatus according to (1) of an embodiment of the present disclosure.

(10) An abnormality determination method of an embodiment of the present disclosure includes: receiving a feature of a reflection wave corresponding to an ultrasonic signal transmitted by each sonar apparatus, and determining an abnormality of each sonar apparatus based on a difference in the feature.

(11) In the abnormality determination method according to (10) of an embodiment of the present disclosure, the feature is at least one of a time of flight, a variation in the time of flight, a wave height, and/or a variation in the wave height.

(12) In the abnormality determination method according to (10) of an embodiment of the present disclosure, a cause of the abnormality is estimated based on the difference in the feature.

(13) The abnormality determination method according to (10) of an embodiment of the present disclosure, further includes: determining whether each sonar apparatus is a sonar apparatus to be subjected to abnormality determination or a sonar apparatus to be subjected to detection of a target object.

(14) In the abnormality determination method according to (13) of an embodiment of the present disclosure, whether each sonar apparatus is the sonar apparatus to be subjected to the abnormality determination or the sonar apparatus to be subjected to the detection of the target object is determined in accordance with a traveling direction of the vehicle.

(15) In the abnormality determination method according to (13) of an embodiment of the present disclosure, the sonar apparatus to be subjected to the detection of the target object is a sonar apparatus other than a sonar apparatus determined to be abnormal.

(16) In the abnormality determination method according to (10) of an embodiment of the present disclosure, the sonar apparatus to be subjected to the detection of the target object is operated in an order excluding the sonar apparatus determined to be abnormal from a predetermined order.

(17) In the abnormality determination method according to (10) of an embodiment of the present disclosure, the sonar apparatus to be subjected to the detection of the target object is operated in a predetermined order, and the abnormality is determined again for the sonar apparatus determined to be abnormal at a timing of the sonar apparatus determined to be abnormal within the predetermined order.

(18) A computer-readable storage medium of an embodiment of the present disclosure stores an abnormality determination program that causes a computer to execute: a reception step of receiving a feature of a reflection wave corresponding to an ultrasonic signal transmitted by each sonar apparatus; and an abnormality determination step of determining an abnormality of each sonar apparatus based on a difference in the feature.

(19) In the vehicle according to (9) of an embodiment of the present disclosure, each sonar apparatus is a sonar apparatus configured to be mounted on the vehicle.

(20) In the vehicle according to (9) of an embodiment of the present disclosure, the abnormality determination apparatus is included in an electronic control unit of the vehicle.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2024-035129 filed on Mar. 7, 2024, the disclosure each of which including the specification, drawings and abstract is incorporated herein by reference in its entirety.

### Industrial Applicability

The present disclosure is applicable to an abnormality determination apparatus, a method, a computer-readable storage medium storing a program, and a vehicle.

### Reference Signs List

100, 211 to 218 Sonar apparatus
110 Controller
111 Transmission/reception controller
112 Detector
120 Transmission circuit
130 Reception circuit
140 Microphone
200 Vehicle
220 Muffler
230 ECU
321 Receiver
322 Object detector
323 Abnormality determiner
324 Sonar controller
325 Collision predictor
326 Travel controller
340 Vehicle speed information acquirer
350 Accelerator
360 Brake

1. An abnormality determination apparatus comprising:
a reception circuitry which, in operation, receives a feature of a reflection wave corresponding to an ultrasonic signal transmitted by each sonar apparatus; and
an abnormality determination circuitry which, in operation, determines an abnormality of each sonar apparatus based on a difference in the feature.

2. The abnormality determination apparatus according to claim 1,
wherein the feature is at least one of a time of flight, a variation in the time of flight, a wave height, and/or a variation in the wave height.

3. The abnormality determination apparatus according to claim 1,
wherein the abnormality determination circuitry which, in operation, estimates a cause of the abnormality based on the difference in the feature.

4. The abnormality determination apparatus according to claim 1, further comprising:
a sonar control circuitry which, in operation, determines whether each sonar apparatus is a sonar apparatus to be subjected to abnormality determination or a sonar apparatus to be subjected to detection of a target object.

5. The abnormality determination apparatus according to claim 4,
wherein the sonar control circuitry which, in operation, determines whether the sonar apparatus is the sonar apparatus to be subjected to the abnormality determination or the sonar apparatus to be subjected to the detection of the target object in accordance with a traveling direction of the vehicle.

6. The abnormality determination apparatus according to claim 4,
wherein the sonar control circuitry which, in operation, determines the sonar apparatus to be subjected to the detection of the target object with a sonar apparatus determined to be abnormal by the abnormality determiner excluded.

7. The abnormality determination apparatus according to claim 6,
wherein the sonar control circuitry which, in operation, operates the sonar apparatus to be subjected to the detection of the target object in an order excluding the sonar apparatus determined to be abnormal from a predetermined order.

8. The abnormality determination apparatus according to claim 4,
wherein the sonar control circuitry which, in operation, operates the sonar apparatus to be subjected to the detection of the target object in a predetermined order; and
the abnormality determination circuitry which, in operation, determines again the abnormality for the sonar apparatus determined to be abnormal at a timing of the sonar apparatus determined to be abnormal within the predetermined order.

9. A vehicle comprising the abnormality determination apparatus according to claim 1.

10. An abnormality determination method comprising:
receiving a feature of a reflection wave corresponding to an ultrasonic signal transmitted by each sonar apparatus, and
determining an abnormality of each sonar apparatus based on a difference in the feature.

11. The abnormality determination method according to claim 10,
wherein the feature is at least one of a time of flight, a variation in the time of flight, a wave height, and/or a variation in the wave height.

12. The abnormality determination method according to claim 10,
wherein a cause of the abnormality is estimated based on the difference in the feature.

13. The abnormality determination method according to claim 10, further comprising:
determining whether each sonar apparatus is a sonar apparatus to be subjected to abnormality determination or a sonar apparatus to be subjected to detection of a target object.

14. The abnormality determination method according to claim 13,
wherein whether each sonar apparatus is the sonar apparatus to be subjected to the abnormality determination or the sonar apparatus to be subjected to the detection of the target object is determined in accordance with a traveling direction of the vehicle.

15. The abnormality determination method according to claim 13,
wherein the sonar apparatus to be subjected to the detection of the target object is a sonar apparatus other than a sonar apparatus determined to be abnormal.

16. The abnormality determination method according to claim 15,
wherein the sonar apparatus to be subjected to the detection of the target object is operated in an order excluding the sonar apparatus determined to be abnormal from a predetermined order.

17. The abnormality determination method according to claim 13,
wherein the sonar apparatus to be subjected to the detection of the target object is operated in a predetermined order, and
the abnormality is determined again for the sonar apparatus determined to be abnormal at a timing of the sonar apparatus determined to be abnormal within the predetermined order.

18. A computer-readable storage medium storing an abnormality determination program that causes a computer to execute:
a reception step of receiving a feature of a reflection wave corresponding to an ultrasonic signal transmitted by each sonar apparatus; and
an abnormality determination step of determining an abnormality of each sonar apparatus based on a difference in the feature.

19. The vehicle according to claim 9,
wherein each sonar apparatus is a sonar apparatus configured to be mounted on the vehicle.

20. The vehicle according to claim 9,
wherein the abnormality determination apparatus is included in an electronic control unit of the vehicle.
